(19) United States
(12) Patent Application Publication
(10) Pub. No.: US 2013/0046645 A1
(43) Pub. Date: Feb. 21, 2013

(54) SYSTEM AND METHOD FOR POINT OF TRANSACTION AUTHENTICATION

(71) Applicants: David M. Grigg, Rock Hill, SC (US); Matthew A. Calman, Charlotte, NC (US)

(72) Inventors: David M. Grigg, Rock Hill, SC (US); Matthew A. Calman, Charlotte, NC (US)

(73) Assignee: Bank of America Corporation, Charlotte, NC (US)

(21) Appl. No.: 13/211,010

(22) Filed: Aug. 16, 2011

(51) Int. Cl. G06Q 30/00

(52) U.S. Cl. 705/26.1

(57) ABSTRACT

Embodiments of the invention provide a method a authenticating a transaction at the point of transaction. In some embodiments of the invention, the user conducts the transaction through the use of a mobile computing device that is capable of communication with a point of transaction device. In some embodiments of the invention, the user authenticates the transaction through the use of the mobile computing device. In some embodiments, a method is provided that includes: (1) receiving information associated with a transaction involving a user; (2) prompting the user to authenticate the transaction; (3) receiving authentication data from the user; and (4) sending information associated with the authentication data.

### BACKGROUND

Consumers conduct transactions in a variety of ways. In some transactions the consumer provides a merchant or vendor with a credit or debt card when paying for goods or services. Often, the consumer provides a merchant or vendor with a credit or debit card at a point of transaction, such as a check-out counter, desk or kiosk. Typically, either the merchant swipes the consumer's card in a payment terminal or the consumer swipes the card themselves in a self-service payment terminal. Regardless of who swipes the card, often, the consumer must authenticate the transaction.

Banks and other issuers of debit and credit cards require a consumer to authenticate a transaction in order to limit unauthorized or fraudulent uses of the card. Frequently, when a consumer makes an in-store purchase, a consumer will be asked to authenticate a credit card transaction by signing a receipt. Alternatively, in instances when a consumer uses a debit card, the consumer often must input a PIN or other numeric identifier to authenticate the transaction. Furthermore, sometimes a consumer may be asked to answer a challenge question in order to authenticate a transaction.

Instead of using debit or credit cards, many mobile phones and other mobile computing devices are equipped with hardware and/or software that allow the mobile computing device to act as an electronic wallet, or “e-wallet”. In other words, the user's mobile computing device is configured to securely store credit card information, debit card information, bank account information, and/or other information about the ways in which the owner of the mobile computing device would like to pay for goods and services. When used in conjunction with payment terminals that are capable of communicating with mobile computing devices over secure networks, such as near field networks, users can employ this e-wallet functionality of their mobile computing devices to pay for transactions. For example, by tapping or otherwise touching an e-wallet equipped mobile computing device to a near field communication payment terminal, the consumer can pay for goods and services using credit card or debit card information that is stored in the e-wallet.

A current problem with the use of e-wallet technology to conduct transactions is that there is not an effective way to prevent unauthorized individuals from using a mobile computing device to pay for goods and/or services. For instance, if a consumer misplaces their mobile computing device or if the mobile computing device is stolen, an unauthorized individual could use the e-wallet functionality of the mobile computing device to conduct unauthorized transactions. The unauthorized third party could simply tap or touch the mobile computing device to e-wallet equipped payment terminal and thus, would be able to make unauthorized purchases using the user's credit card information, debit card information, and/or other financial information. Accordingly, there exists a need for an improved system for authenticating transactions in which a user uses a mobile computing device to conduct transactions. In particular, there exists a need for an improved system for authenticating transactions that are being conducted through the use of a mobile computing device while the user is still physically located at the point of transaction.

### BRIEF SUMMARY

Embodiments of the invention relate to apparatuses, methods, and computer program products that allow a consumer to authenticate a transaction through the use of a mobile computing device while the user is still located at the point of transaction. In some embodiments of the invention, the mobile computing device is a mobile phone.

In some embodiments, the mobile computing device receives a request to authenticate the financial transaction. Additionally, the mobile computing device prompts the user, via the mobile computing device, to authenticate the financial transaction. The mobile computing device also receives, based upon the user's interaction with the mobile computing device, authentication data from the user. Lastly, the mobile computing device sends wirelessly information associated with the authentication data.

In some embodiments, the mobile computing device receives wirelessly a request to authenticate the financial transaction from a point of transaction device. In some of these embodiments, the mobile computing device receives a request to authenticate the financial transaction from a point of transaction device via a near field communication network. In other embodiments, the mobile computing device receives wirelessly a request to authenticate the financial transaction from a network device in communication with the mobile computing device. In some embodiments, the mobile computing device receives a request to authenticate the financial transaction before the user commences the financial transaction.

In some embodiments, the mobile computing device receives, based upon the user's interaction with the mobile computing device, authentication data from the user that comprises a PIN number. In other embodiments, the mobile computing device receives, based upon the user's interaction with the mobile computing device, authentication data from the user that comprises an answer to a challenge question. In yet some other embodiments, the mobile computing device receives, based upon the user's interaction with the mobile computing device, authentication data from the user that comprises biometric information. In some embodiments, the biometric information comprises the user's voice.

In some embodiments, the mobile computing device sends the authentication data to a point of transaction device. In yet some other embodiments, the mobile computing device sends the authentication data to a network device in communication with the mobile computing device.

In some embodiments of the invention, the mobile computing device is further configured to perform the step of verifying whether the authentication data is correct. In some of these embodiments, where the mobile computing device sends wirelessly information associated with the authentication data, the mobile computing device sends an indication of whether or not the authentication data is correct to the point of transaction device.

In some embodiments of the invention, the mobile computing device is further configured to perform the step of displaying a bar code on the display of the mobile computing device, wherein the barcode provides an indication that the authentication data is correct. In some other embodiments of the invention, the mobile computing device is further configured to perform the step of displaying an indicia on the display of the mobile computing device, wherein the indicia provides an indication that the authentication data is correct.

The features, functions, and advantages that have been discussed may be achieved independently in various embodiments of the present invention or may be combined with yet other embodiments, further details of which can be seen with reference to the following description and drawings. Additionally, as will be appreciated by one of ordinary skill in the art, the features, functions, and advantages that have been discussed may include and/or be embodied as an apparatus (including, for example, a system, machine, device, computer program product, and/or the like), as a method (including, for example, a business method, computer-implemented process, and/or the like), or as any combination of the foregoing.

### BRIEF DESCRIPTION OF THE DRAWINGS

Having thus described embodiments of the invention in general terms, reference will now be made the accompanying drawings, wherein:

FIG. 1 is a flow diagram illustrating a general process flow for point of transaction authentication, in accordance with an embodiment of the invention;

FIG. 2 is a flow diagram illustrating a more-detailed process flow of an embodiment for point of transaction authentication;

FIG. 3 is a flow diagram illustrating a more-detailed process flow of another embodiment for point of transaction authentication;

FIG. 4 provides a block diagram illustrating an system and environment configured to perform point of transaction authentication, in accordance with an embodiment of the invention;

FIG. 5 provides a block diagram illustrating the user's mobile computing device of FIG. 4, in accordance with an embodiment of the invention;

FIG. 6 provides a block diagram illustrating the financial institution's computer system of FIG. 4, in accordance with an embodiment of the invention;

FIG. 7 provides a block diagram illustrating the point of transaction computer system of FIG. 4, in accordance with an embodiment of the invention;

FIG. 8 is a mixed block and flow diagram of a system configured to perform point of transaction authentication, in accordance with an embodiment of the invention.

FIG. 9 is a mixed block and flow diagram of a system configured to perform point of transaction authentication, in accordance with an embodiment of the invention.

FIG. 10 is a mixed block and flow diagram of a system configured to perform point of transaction authentication, in accordance with an embodiment of the invention.

### DETAILED DESCRIPTION OF EMBODIMENTS OF THE INVENTION

### Method for Transaction Authentication

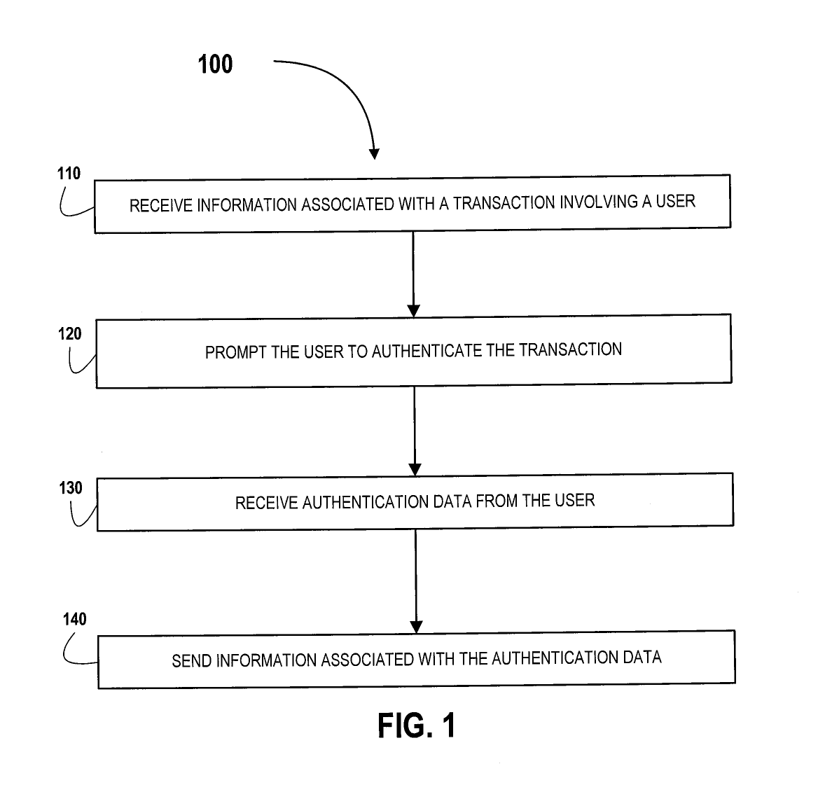

Referring now to FIG. 1, a general process flow 100 is provided for authenticating a transaction at a point of transaction. In some embodiments, the process flow 100 is performed by a system (i.e., one or more apparatuses) having hardware and/or software configured to perform one or more portions of the process flow 100. In such embodiments, as represented by block 110, the system is configured to receive information associated with a transaction involving a user. As represented by block 120, the system is also configured to prompt the user to authenticate the transaction. As represented by block 130, the system is also configured to receive authentication data from the user. Lastly, as represented by block 140, the system is configured to send information associated with the authentication data.

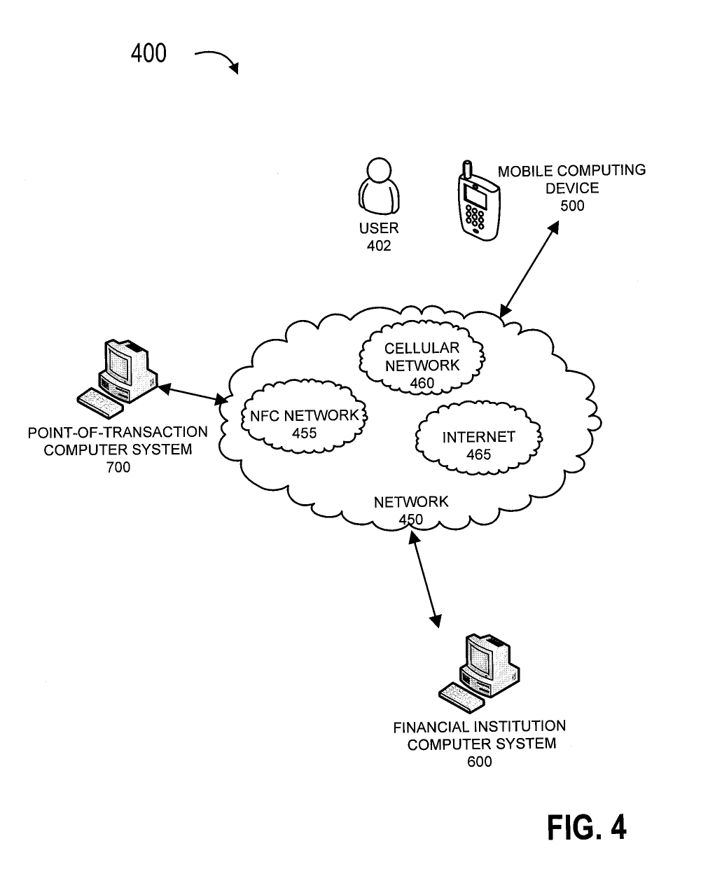

It will be understood that the system having the process flow 100 can include one or more separate and/or different apparatuses. For example, in some embodiments of the invention, a single apparatus (e.g., mobile computing device 500 described in connection with FIG. 4) is configured to perform all of the portions of process flow 100 represented by blocks 110 to 140. However, in some other embodiments, a first apparatus (e.g., financial institution computer system 600 described in connection with FIG. 4) is configured to perform the portions of process flow 100 represented by block and 110 and 120 and a second apparatus (e.g., mobile computing device 500 described in connection with FIG. 4) is configured to perform the portions of process flow 100 represented by blocks 130, and 140.

Regarding block 110, the phrase “transaction involving a user” means any type of financial transaction in which a user participates. In some embodiments, the transaction is one in which the user is purchasing certain goods or services from another party, such as a vendor or merchant. In other embodiments, the user may be receiving money or other funds from a third party or transferring money or other funds to a third party. As one of skill in the art will appreciate, the phrase “transaction involving the user” can be any type of financial transaction in which goods, services, money, and/or other items of value are exchanged between two or more individuals or entities (e.g., purchase of goods or services, a return of goods or services, a payment transaction, a credit transaction, or other interaction involving a user's bank account, credit account, a debit/deposit account or the like, etc.).

In some embodiments, the transaction may require the user to approach a point of transaction device, such as a point of transaction computer system and/or payment terminal. In some embodiments, the point of transaction computer system may comprise a cash register and/or payment terminal. In other embodiments, the payment terminal may be a separate point of transaction device. In some embodiments, the payment terminal provides the user with functionality to conduct a transaction, such as functionality to swipe a credit card, functionality to swipe a debit card, functionality to input a PIN number or other data used to authenticate a transaction, and/or functionality to use the e-wallet capability of a mobile computing device. In other embodiments of the invention, a payment terminal comprises only a device capable of communicating with a mobile device. In these embodiments, the payment terminal does not include any functionality for swiping a card (e.g., debit card, credit card, etc.) or inputting any PIN numbers or any other data used to authenticate a transaction.

In some embodiments, the payment terminal may comprise a near field communication payment terminal. In these embodiments, where the user's mobile computing device (also referred to herein as a “mobile device”) is equipped with e-wallet functionality, a user may tap or physically touch the user's mobile computing device against the near field communication terminal to initiate the transaction. In some embodiments, a user may tap the user's mobile computing device against the near field communication terminal in order to pay for goods and/or services. In other embodiments, a user may tap the user's mobile computing device against the near field communication terminal in order to send or received money or other funds. In other embodiments, the user may not tap or physically touch the user's mobile computing device against the payment terminal in order to interact with the payment terminal. In yet some other embodiments, the payment terminal may use any other type of communication protocol other than near field communication technology to enable a user to use the e-wallet functionality of the user's mobile computing device.

In some embodiments of block 110 the transaction may involve the user's mobile computing device communicating with the point of transaction device over a network. In some embodiments, the user's mobile computing device and the point of transaction device communicate over a wireless network, such as a cellular communication network, near field communications network, Bluetooth network, and/or another wireless network. In some other embodiments, the transaction may involve the user's mobile computing device and the point of transaction device communicating over a wireline network.

Further concerning block 110, the phrase “information associated with a transaction involving a user” means any quantity and/or type of information associated with a transaction involving a user. In some embodiments, the information associated with a transaction involving a user may be a request to authenticate the transaction. In some embodiments, the request is sent from a point of transaction device. In some other embodiments, the request is inputted by the user of the system configured to perform process flow 100. In other embodiments, the information associated with a transaction involving a user may be a notification that the user has commenced the transaction, which in some embodiments, may be sent from a point of transaction device. In other embodiments, the information associated with a transaction involving a user may be a notification that the user and/or the system is physically located near a point of transaction device. In some other embodiments of the invention, the information associated with the transaction involving the user may be information that identifies the user, such as the user's name, bank account number, debit card number, credit card number, or telephone number, etc.

Lastly, at block 110, the system configured to perform the process flow 100 may “receive” the information associated with a transaction involving a user according to any method know to one skilled in the art. In some embodiments, the system receives the information over a wireless network, such as a cellular communications network, near field communications network, Bluetooth network and/or another wireless network. In some other embodiments, the system may receive the information over a wireline network. In some embodiments of the invention, the system configured to receive information associated with a transaction involving a user may be a mobile computing device, such as mobile computing device 500 of FIG. 4. In such embodiments, mobile computing device 500 may receive the information associated with a transaction involving a user from a point of transaction device, such a point of transaction computer system 700 from FIG. 4 and/or payment terminal. In other embodiments, mobile computing device 500 may receive information associated with a transaction involving a user from another device that can communicate with mobile computing device 500 over a network, such as financial institution computer system 600 from FIG. 4. In yet some other embodiments, the mobile computing device may receive information associated with a transaction involving a user via a user's interaction with the mobile computing device (e.g., opening a mobile application, etc.).

In some embodiments, particularly where a mobile computing device is configured to perform process flow 100, the mobile computing device may receive information associated with a transaction involving a user before the user commences the transaction. For example, in some embodiments, the user may open an authentication application on the mobile computing device that allows the user to authenticate the transaction while still waiting in line to access a point of transaction device. In some other embodiments, the mobile computing device may receive an indication from a point of transaction device (via a NFC, Bluetooth or other wireless communication protocol) that the mobile computing device is within the proximity of a point of transaction device. The mobile computing device may receive this indication while the user is waiting in line to access the point of transaction device. However, in some other embodiments, the mobile computing device may receive information associated with a transaction involving a user before the user commences the transaction. For example, the mobile computing device may receive information associated with a transaction involving a user after the user has bumped, tapped or otherwise physically touched the mobile computing device to a NFC payment terminal (or other payment terminals with similar e-wallet functionality).

At block 120 of process flow 100 the phrase “authenticate the transaction” may mean any method in which a user can authenticate a transaction involving the user. In some embodiments of the invention, the user can authenticate the transaction by providing the system configured to perform process flow 100 with a personal identification number, or PIN number. The system could then compare this PIN number to stored information to verify that the PIN number is correct. In other embodiments of the invention, the user could answer a challenge question, such as “what is your mother's maiden name” or “what was the name of your first pet”, etc. in order to authenticate the transaction. In other words, if the user provides the correct answer to the challenge question, then the transaction would be authenticated. In other embodiments, the user may provide the system configured to perform process flow 100 with biometric data, including but not limited to an analysis of the user's voice, a fingerprint scan, or a retina scan to authenticate the transaction. In these embodiments, if the biometric data matches stored data about the user, then the transaction is authenticated. As one of ordinary skill in the art will appreciate, the system configured to perform process flow 100 may use any means to authenticate the transaction. Additionally, the system may employ any type of functionality, including without limitation a keypad, touch screen, retina scanner, fingerprint scanner, or voice analysis software to perform the authentication.

In some embodiments of the invention, the user may authenticate the transaction before the user has commenced the transaction (i.e., while the user is waiting in line to access a point of transaction device, etc.) and in other embodiments of the invention, the user may authenticate the transaction after the user has commenced the transaction (i.e., after the user has tapped, bumped or otherwise physically touched a mobile device to a NFC payment terminal, etc.)

With regards to block 120, the system may “prompt” the user to authenticate the transaction using any known methods. In some embodiments, where the system configured to perform process flow 100 is a mobile computing device, the mobile computing device may display a dialog box or other graphical indicator to prompt the user to authenticate the transaction. In other embodiments, the mobile computing device may emit a sound and/or vibrate so as to alert a user to authenticate the transaction. In other embodiments, the system configured to perform process flow 100 may prompt the user to authenticate the transaction by calling a telephone associated with the user, sending an email to an account associated with the user, or sending a text message to a mobile computing device associated with the user.

In some embodiments of the invention, the system may prompt the user to authenticate the transaction before the user has commenced the transaction (i.e., while the user is waiting in line to access a point of transaction device, etc.) and in other embodiments of the invention, the system may prompt the user to authenticate the transaction after the user has commenced the transaction (i.e., after the user has tapped, bumped or otherwise physically touched a mobile device to a NFC payment terminal, etc.)

At block 130, the term “authentication data” refers to any data or information that the user provides to the system configured to perform process flow 100 to authenticate the transaction, as discussed in relation to block 120. In some embodiments, the authentication data may comprise a PIN number. In other embodiments, the authentication data may comprise the answer to a challenge question. In other embodiments, the authentication data may comprise biometric data, such as information associated with a retina scan, fingerprint scan, voice analysis and/or any other type of biometric data that may be used to indentify an individual. In still some other embodiments, the authentication data may comprise information associated with a gesture or other movement of a user's body, where the gesture or movement is used to authenticate the transaction. For example, in some embodiments, the mobile computing device associated with the user may analyze a gesture to determine whether it matches a pre-determined gesture used to authenticate the transaction.

Further, in connection with block 130, the system configured to perform process flow 100 may receive the authentication data through any method and/or functionality known to one of skill in the art. For example, the system may receive the authentication data by allowing a user to interact with the system and input the authentication data through the use of a keyboard, keypad, touch screen, mouse and/or similar functionality. Additionally, the system may receive the authentication data through the use of a microphone, where the user's voice or the words spoken by the user comprises the authentication data. Furthermore, the system configured to perform process flow 100 could receive the information through retina scan functionality, voice recognition functionality, fingerprint identification functionality, and/or any other functionality known in the art relating to the acquisition of biometric information. Lastly, in some embodiments, the system receives the information over a wireless network, such as a cellular communications network, near field communications network, and/or another wireless network. In some other embodiments, the system may receive the information over a wireline network, including without limitation a wireline network that connects input functionality, such as a keyboard or touch screen, etc. to a processing device or memory device.

In some embodiments of the invention, the system may receive authentication data before the user has commenced the transaction (i.e., while the user is waiting in line to access a point of transaction device, etc.) and in other embodiments of the invention, the system may receive authentication data after the user has commenced the transaction (i.e., after the user has tapped, bumped or otherwise physically touched a mobile device to a NFC payment terminal, etc.)

Lastly, with regards to block 140, the phrase “information associated with the authentication data” means any quantity and/or type of information associated with the authentication data. In some embodiments of the invention, the information associated with the authentication data may be the authentication data. In other embodiments of the invention, the information associated with the authentication data may be an indication of whether the authentication data that the user inputted is correct or not.

In connection with block 140, the system configured to perform process flow 100 may used any method to “send” the information associated with the authentication data. In some embodiments of the invention, the system may send the information associated with the authentication data over a wireless network, such as a cellular communications network, near field communications network, and/or another wireless network. In some other embodiments, the system may send the information associated with the authentication data over a wireline network. In some embodiments, where a mobile computing device is configured to perform process flow 100, the mobile computing device may send the information associated with the authentication data to a point of transaction device, such as a point of transaction computer system 700 from FIG. 4. In other embodiments, the mobile computing device may send the information associated with the authentication data to any other device configured to communicate with the mobile computing device over a network, such financial institution computer system 600 from FIG. 4.

As used herein, the term “financial institution” refers to an institution that is associated with the user. Financial institutions can include, but are not limited to, banks, building societies, credit unions, stock brokerages, asset management firms, savings and loans, money lending companies, insurance brokerages, insurance underwriters, dealers in securities, and similar businesses. In some embodiments, the financial institution may be a bank that issued the user's credit card or debit card. In other embodiments, the financial institution may be where the user has a financial institution account. In yet some other embodiments, the term financial institution may refer to a third party that stores information used to authenticate financial transactions involving the user.

As discussed below, in some embodiments of block 140, the system may send the authentication data. In some embodiments of block 140, a mobile computing device may send the authentication data to a point of transaction device. Although not depicted in process flow 100, the point of transaction device may subsequently determine whether the authentication data is correct or not. The point of transaction device may use any method to determine if the authentication data is correct or not. In some embodiments, the point of transaction device may send (via wireless or wireless communication channels) the authentication data to a financial institution computer system in order to verify that the authentication data is correct or not. Upon receiving the authentication data, the financial institution computer system may compare the authentication data to stored information about the user. The stored information may comprise information that is necessary to authenticate transactions involving the user (e.g., passwords, PIN numbers, answers to challenge questions, biometric data, etc.) that may have been stored at an earlier point in time (i.e., when the user opened a bank account, activated a credit card or debit card, or enrolled in security features, etc.) If the authentication data matches the stored information (which may be stored in a memory device that is accessible to the third party computer system), then the authentication data is correct and the transaction is authenticated. In some embodiments, the financial institution computer system may subsequently send an indication to the point of transaction device and/or mobile computing device that the authentication data is correct and the transaction is authenticated.

Additionally, as discussed above, in some other embodiments of block 140, where the information associated with the authentication data is an indication of whether the authentication data is correct or not, the system configured to perform process flow 100 may further be configured to determine, or verify whether the authentication data is correct or not. Although not show in FIG. 1, the system could determine whether the authentication data is correct or not between block 130 and block 140. The system may use any method to determine whether the authentication data is correct or not, including the previously discussed method of sending the authentication data to a financial institution computer system for comparison with stored information. Additionally, the system itself may store the stored information, and the system itself could compare the authentication data to the stored information to determine if the authentication data is correct or not.

Furthermore, where the system configured to perform process flow 100 is a mobile computing device, the mobile computing device may be configured to display indicia or a bar code on the mobile computer device display if the user provides the correct authentication data. Thus, in some alternative embodiments not described in relation to FIG. 1, the user could show or otherwise provide the indicia or bar code to the point of transaction device in order to authenticate the transaction. As one of skill in the art will appreciate, the mobile computing device could be configured to display an indicia or bar code that when scanned, or “read” by the point of transaction device, provides a notification to the point of transaction device that the transaction is authenticated.

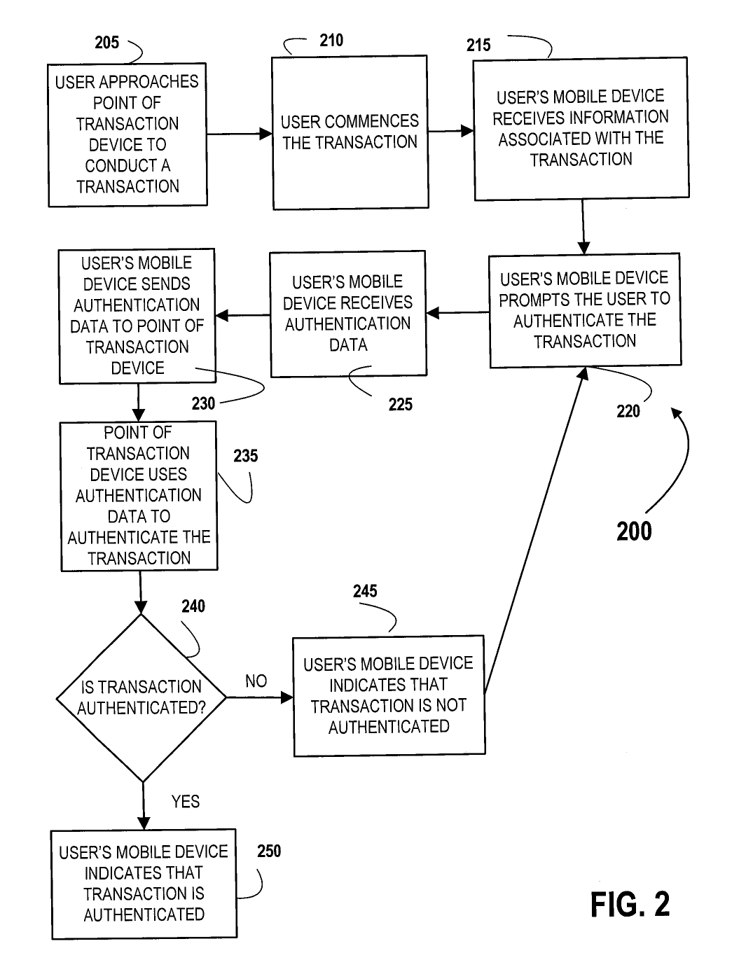

Referring now to FIG. 2, a more detailed process flow 200 is presented for authenticating a transaction at a point of transaction, in accordance with an embodiment of the present invention. In some embodiments, one ore more of the portions of process flow 200 are performed by an apparatus having hardware and/or software configured to perform one or more portions of process flow 200. In some of these embodiments, the apparatus configured to perform process flow 100 is also configured to perform process flow 200. As such, it will be understood that process flow 200 illustrated in FIG. 2 represents and example embodiments of the process flow 100 discussed in connection with FIG. 1.

As represented by block 205, a user approaches a point of transaction device to conduct a transaction. In some embodiments of the invention, the user approaches a point of transaction device to pay for goods or services that are being sold and/or provided by a merchant. In other embodiments of the invention, the user approaches a point of transaction device to either send money or other funds to a third party and/or receive money or funds from a third party. As one of skill in the art will appreciate the user may approach the point of transaction device to conduct any type of transaction.

In some embodiments of block 205, the point of transaction device comprises a point of transaction computer system. In some embodiments, the point of transaction computer system may comprise a cash register and/or payment terminal. In some embodiments, the payment terminal provides the user with functionality to conduct a transaction. In some further embodiments, the payment terminal may comprise a near field communication payment terminal or any other type of communication terminal that can communicate with a mobile computing device over a network.

At block 210, the user commences the transaction. In some embodiments, the user uses a mobile computing device, including but not limited to a mobile phone, to commence the transaction. In these embodiments, the mobile computing device may be configured to perform e-wallet functionality that would enable the user to commence transactions through the use of the mobile computing device. In some instances, the mobile computing device may store information relating to the user's bank account, credit cards, debit cards or other payment options, and the mobile computing device may communicate this stored information to the payment terminal as part of a transaction.

In some embodiments of the invention, where the payment terminal comprises a near field communication terminal, the user may commence the transaction by tapping, touching, or physically pressing the mobile computing device to the payment terminal. In other embodiments, the user may use other wireless communication protocols, such as Bluetooth or a wireless internet connection, to commence the transaction through the use of a mobile computing device. In yet some other embodiments, the user may use a wireline communication network to commence the transaction through the use of a mobile computing device.

Returning back to block 210, in some embodiments of the invention, the user may commence the transaction by swiping a credit card or debit card. In some embodiments of the invention, the user swipes the credit card or debit card at a payment terminal. In other embodiments, a third party, such as the employee of a store, swipes the credit card or debit card.

At block 215, subsequent to the user commencing the transaction, the user's mobile computing device receives information associated with the transaction. In some embodiments of the invention, the user's mobile computing device receives information associated with the transaction from a point of transaction device, which may comprise a point of transaction payment terminal. In other embodiments of the invention, the user's mobile computing device may receive information associated with the transaction from a device that may communicate with the mobile computing device over a network, such as a computer system associated with the user's financial institution. The mobile computing device may receive information associated with the transaction via a wireless or wireline communication network.

In some embodiments of the invention, the information associated with the transaction is an indication that the user commenced the transaction at block 210. In other embodiments of the invention, the information associated with the transaction may be a request that the user authenticate the transaction. In still other embodiments of the invention, the information associated with the transaction is any other type of information relating to the transaction, including without limitation, the user's credit card number, the user's debit card number, the user's name, the user's address, or the user's bank account number.

At block 220, the user's mobile computing device prompts the user to authenticate the transaction. The mobile computing device may prompt the user to authenticate the transaction using any known method. In some embodiments, the mobile computing device may display a dialog box or other graphical interface to prompt the user to authenticate the transaction. In other embodiments, the mobile computing device may emit a sound and/or vibrate so as to alert a user to authenticate the transaction.

Additionally, at block 220, the mobile computing device may use any method and/or functionality to enable the user to authenticate the transaction. In some embodiments, the user can authenticate the transaction by providing the mobile computing device with a personal identification number, or PIN number. In other embodiments of the invention, the user could answer a challenge question, such as “what is your mother's maiden name” or “what was the name of your first pet”, etc. in order to authenticate the transaction. In other embodiments, the mobile computing device may be equipped to capture biometric data of the user, including but not limited to an analysis of the user's voice, a fingerprint scan, or a retina scan to authenticate the transaction. As one of ordinary skill in the art will appreciate, the mobile computing device may employ any type of functionality, including without limitation a keypad, touch screen, retina scanner, fingerprint scanner, or voice analysis software to enable the user to authenticate the transaction.

At block 225, the mobile computing device receives the user's authentication data. The authentication data refers to any data or information that the user provides to the mobile computing device to authenticate the transaction. In some embodiments, the authentication data may comprise a PIN number. In other embodiments, the authentication data may comprise the answer to a challenge question. In other embodiments, the authentication data may comprise biometric data, such as information associated with a retina scan, fingerprint scan, voice analysis and/or any other type of biometric data that may be used to indentify an individual.

Additionally, at block 225, the mobile computing device may receive the authentication data through any method and/or functionality known to one of skill in the art. For example, the mobile computing device may receive the authentication data by allowing a user to input the authentication data through the use of a keyboard, keypad, touch screen, mouse and/or similar functionality. Additionally, the mobile computing device may receive the authentication data through the use of a microphone, where the user's voice or the words spoken by the user comprises the authentication data. Furthermore, the mobile computing device may receive the information through retina scan functionality, voice recognition functionality, fingerprint identification functionality, and/or any other functionality known in the art relating to the acquisition of biometric information.

At block 230, the mobile computing device sends the authentication data, which it received at block 225, to the point of transaction device. The mobile computing device sends the authentication data to the point of transaction device via a network. As discussed above in relation to block 205, in some embodiments of the invention, the point of transaction device may comprise a payment terminal. In some further embodiments the payment terminal may comprise a near field communication payment terminal that can communicate with the mobile computing device over a near field communication network. In still some other embodiments, the payment terminal may communicate with the mobile computing device via other types of wireless networks and/or wireline networks.

At block 235, the point of transaction device receives the authentication data and uses the authentication data to authenticate the transaction. In some embodiments of the invention, the point of transaction device may send the authentication data to a financial institution computer system. Upon receiving the authentication data, the financial institution computer system may compare the authentication data to stored information about the user. The stored information may comprise information that is necessary to authenticate transactions involving the user (e.g., passwords, PIN numbers, answers to challenge questions, biometric data, etc.) that may have been stored at an earlier point in time (i.e., when the user opened a bank account, activated a credit card or debit card, or enrolled in security features, etc.) If the authentication data matches the stored information (which may be stored in a memory device that is accessible to the computer system), then the authentication data is correct and the transaction is authenticated.

In some embodiments of block 235, the point of transaction device sends the authentication data to the financial institution computer system via a communications network, which may be either wireless and/or wireline. Similarly, the financial institution computer system may send an indication of whether the authentication data is correct or not (i.e., is the transaction authenticated) to the point of transaction device and/or mobile computing device via a wireless and/or wireline communications network.

At block 240, if the authentication data that was received by the mobile computing device at block 225 is not correct, then the transaction is not authenticated and the process flow 200 moves to block 245. At block 245, the user's mobile computing device indicates that the transaction is not authenticated. In some embodiments of block 245, the point of transaction device sends information to the mobile computing device that notifies the mobile computing device that the transaction is not authenticated. In some embodiments of the invention, the point of transaction device sends this information to the mobile computing device via a near field communication network. In other embodiments, the point of transaction device sends this information to the mobile computing device via a different type of wireless network and/or a wireline network. In still some other embodiments, the financial institution computer system sends information to the mobile computing device that notifies the mobile computing device that the transaction is not authenticated. Upon receiving the information that the transaction is not authenticated, the mobile computing device indicates to the user the transaction is not authenticated. The mobile computing device may use any known method to indicate to the user that the transaction is not authenticated. In some embodiments, the mobile computing device may display a dialog box or other graphical interface to indicate that the transaction is not authenticated. In other embodiments, the mobile computing device may emit a sound and/or vibrate to indicate that the transaction is not authenticated.

Further, in some embodiments of block 245, if the mobile computing device indicates that the transaction is not authenticated, the process flow may return the block 220, where the user's mobile computing device prompts the user to authenticate the transaction. The process flow may then repeat the processes of block 220 to 240 any number of times until the user authenticates the transaction. Additionally, although not depicted in process flow 200, in some embodiments, if the user fails to property authenticate the transaction after a certain number of attempts (which can be predetermined by any party, including the user, the other party to the transaction, the user's financial institution, etc.), the user's mobile computing device may provide an indication that the transaction is cancelled because the user has failed to authenticate the transaction. Additionally, in some further embodiments, if the transaction is cancelled because the user failed to authenticate the transaction, the system configured to perform the steps of process flow 200 may be further configured to send a notice of the failed transaction to an email address, cell phone number, mailing address, or other contact information associated with a credit card or debit card that was used in the transaction.

Returning back to block 240, if the authentication data that was received by the mobile computing device at block 225 is correct, then the transaction is authenticated and the process flow 200 moves to block 250. At block 250, the user's mobile computing device indicates that the transaction is authenticated. In some embodiments of block 250, the point of transaction device sends information to the mobile computing device that notifies the mobile computing device that the transaction is authenticated. In some embodiments of the invention, the point of transaction device sends this information to the mobile computing device via a near field communication network. In other embodiments, the point of transaction device sends this information to the mobile computing device via a different type of wireless network and/or a wireline network. In still some other embodiments, the financial institution computer system sends information to the mobile computing device that notifies the mobile computing device that the transaction is authenticated. Upon receiving the information that the transaction is authenticated, the mobile computing device indicates the user as such. The mobile computing device may use any known method to indicate to the user that the transaction is authenticated. In some embodiments, the mobile computing device may display a dialog box or other graphical interface to indicate that the transaction is authenticated. In other embodiments, the mobile computing device may emit a sound and/or vibrate to indicate that the transaction is authenticated.

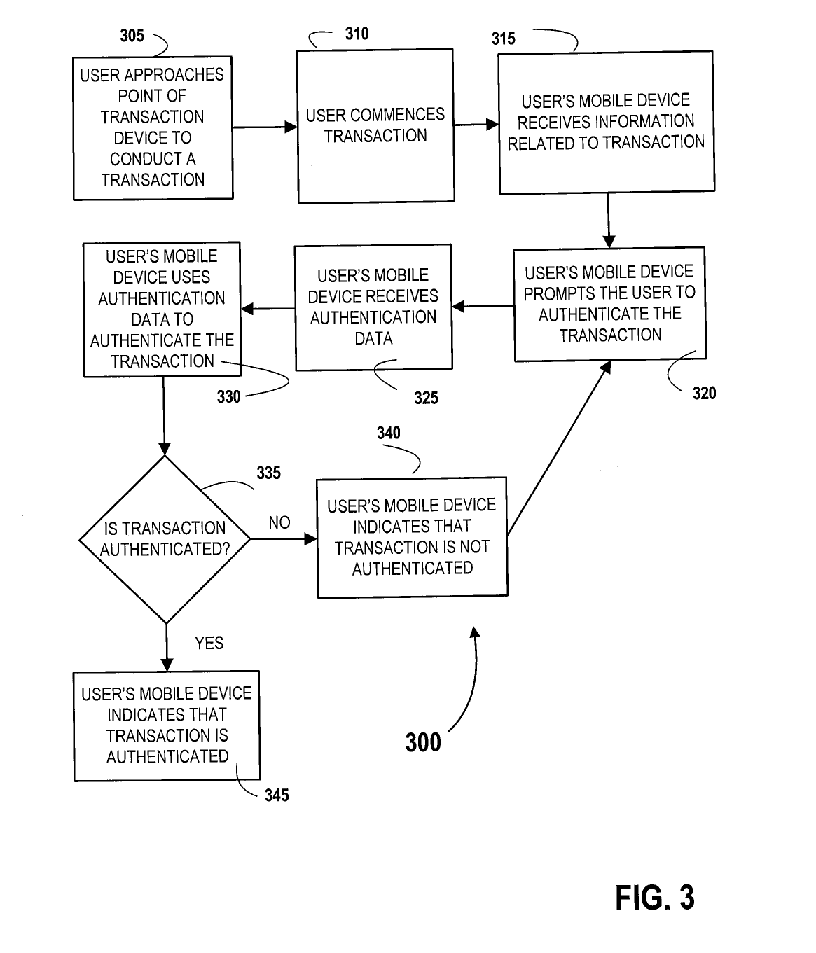

Referring now to FIG. 3, a more detailed process flow 300 is presented for authenticating a transaction at a point of transaction, in accordance with an embodiment of the present invention. In some embodiments, one ore more of the portions of process flow 300 are performed by an apparatus having hardware and/or software configured to perform one or more portions of process flow 300. In some of these embodiments, the apparatus configured to perform process flow 100 is also configured to perform process flow 300. As such, it will be understood that process flow 300 illustrated in FIG. 3 represents and example embodiments of the process flow 100 discussed in connection with FIG. 1.

As represented by block 305, a user approaches a point of transaction device to conduct a transaction. In some embodiments of the invention, the user approaches a point of transaction device to pay for goods or services that are being sold and/or provided by a merchant. In other embodiments of the invention, the user approaches a point of transaction device to either send money or other funds to a third party and/or receive money or funds from a third party. As one of skill in the art will appreciate the user may approach the point of transaction device to conduct any type of transaction.

In some embodiments of block 305, the point of transaction device comprises a point of transaction computer system. In some embodiments, the point of transaction computer system may comprise a cash register and/or payment terminal. In some embodiments, the payment terminal provides the user with functionality to conduct a transaction. In some further embodiments, the payment terminal may comprise a near field communication payment terminal or any other type of communication terminal that can communicate with a mobile computing device over a wireless network.

At block 310, the user commences the transaction. In some embodiments, the user uses a mobile computing device, including but not limited to a mobile phone, to commence the transaction. In these embodiments, the mobile computing device may comprise electronic wallet, or e-wallet functionality that would enable the user to commence transactions through the use of the mobile computing device. In some instances, the mobile computing device may store information relating to the user's bank account, credit cards, debit cards or other payment options, and the mobile computing device may communicate this stored information to the payment terminal as part of a transaction.

In some embodiments of the invention, where the payment terminal comprises a near field communication terminal, the user may commence the transaction by tapping, touching, or physically pressing the mobile computing device to the payment terminal. In other embodiments, the user may use other wireless communication protocols, such as Bluetooth or a wireless internet connection, to commence the transaction through the use of a mobile computing device. In yet some other embodiments, the user may use a wireline communication network to commence the transaction through the use of a mobile computing device.

Returning back to block 310, in some other embodiments of the invention, the user may commence the transaction by swiping a credit card or debit card. In some embodiments of the invention, the user swipes the credit card or debit card at a payment terminal. In other embodiments, a third party, such as the employee of a store, swipes the credit card or debit card.

At block 315, subsequent to the user commencing the transaction, the user's mobile computing device receives information associated with the transaction. In some embodiments of the invention, the user's mobile computing device receives information related to the transaction from a point of transaction device, which may comprise a point of transaction payment terminal. In other embodiments of the invention, the user's mobile computing device may receive information related to the transaction from a device that may communicate with the mobile computing device over a network, such as a computer system associated with the user's financial institution. The mobile computing device may receive information associated with the transaction via a wireless or wireline communication network.

In some embodiments of the invention, the information associated with the transaction is an indication that the user commenced the transaction at block 310. In other embodiments of the invention, the information associated with the transaction may be a request that the user authenticate the transaction. In still other embodiments of the invention, the information associated with the transaction is any other type of information relating to the transaction, including without limitation, the user's credit card number, the user's debit card number, the user's name, the user's address, or the user's bank account number.

At block 320, the user's mobile computing device prompts the user to authenticate the transaction. The mobile computing device may prompt the user to authenticate the transaction using any known method. In some embodiments, the mobile computing device may display a dialog box or other graphical interface to prompt the user to authenticate the transaction. In other embodiments, the mobile computing device may emit a sound and/or vibrate so as to alert a user to authenticate the transaction.

Additionally, at block 320, the mobile computing device may use any method and/or functionality to enable the user to authenticate the transaction. In some embodiments, the user can authenticate the transaction by providing the mobile computing device with a personal identification number, or PIN number. In other embodiments of the invention, the user could answer a challenge question, such as “what is your mother's maiden name” or “what was the name of your first pet”, etc. in order to authenticate the transaction. In other embodiments, the mobile phone may be equipped to capture biometric data of the user, including but not limited to an analysis of the user's voice, a fingerprint scan, or a retina scan to authenticate the transaction. As one of ordinary skill in the art will appreciate, the mobile computing device may employ any type of functionality, including without limitation a keypad, touch screen, retina scanner, fingerprint scanner, or voice analysis software to enable the user to authenticate the transaction.

At block 325, the mobile computing device receives the user's authentication data. The authentication data refers to any data or information that the user provides to the mobile phone to authenticate the transaction. In some embodiments, the authentication data may comprise a PIN number. In other embodiments, the authentication data may comprise the answer to a challenge question. In other embodiments, the authentication data may comprise biometric data, such as information associated with a retina scan, fingerprint scan, voice analysis and/or any other type of biometric data that may be used to indentify an individual.

Additionally, at block 325, the mobile computing device may receive the authentication data through any method and/or functionality known to one of skill in the art. For example, the mobile computing device may receive the authentication data by allowing a user to input the authentication data through the use of a keyboard, keypad, touch screen, mouse and/or similar functionality. Additionally, the mobile computing device may receive the authentication data through the use of a microphone, where the user's voice or the words spoken by the user comprises the authentication data. Furthermore, the mobile computing device may receive the information through retina scan functionality, voice recognition functionality, fingerprint identification functionality, and/or any other functionality known in the art relating to the acquisition of biometric information.

At block 330, after receiving the authentication data in block 325, the mobile computing device uses the authentication data to authenticate the transaction. In some embodiments of the invention, the mobile computing device may send the authentication data to a financial institution computer system. Upon receiving the authentication data, the financial institution computer system may compare the authentication data to stored information about the user. The stored information may comprise information that is necessary to authenticate transactions involving the user (e.g., passwords, PIN numbers, answers to challenge questions, biometric data, etc.) that may have been stored at an earlier point in time (i.e., when the user opened a bank account, activated a credit card or debit card, or enrolled in security features, etc.) If the authentication data matches the stored information (which may be stored in a memory device that is accessible to the computer system), then the authentication data is correct and the transaction is authenticated.

In some embodiments of block 330, the mobile computing device sends the authentication data to the financial institution computer system via a communications network, which may be either wireless and/or wireline. Similarly, the financial institution computer system may send an indication of whether the authentication data is correct or not (i.e., is the transaction authenticated) to the mobile computing device and/or point of transaction computer device via a wireless and/or wireline communications network.

In some other embodiments of block 330, the mobile computing device itself may itself authenticate the authentication data received from the user at block 325. In these embodiments, instead of sending the authentication data to a financial institution computer system for comparison with stored data, the mobile computing device itself may compare the authentication data to information that is stored within a memory device of the mobile computing device. Thus, if the authentication data matches the stored information in the mobile computing device, then authentication data is correct and the transaction is authenticated. If the authentication data does not match the stored information in the mobile computing device, then authentication data is incorrect and the transaction is not authenticated. In some embodiments, the mobile computing device is configured to notify the point of transaction device of whether the transaction is authenticated or not.

At block 335, if the authentication data that was received by the mobile computing device at block 325 is not valid, then the transaction is not authenticated and the process flow 300 moves to block 340. At block 340, the user's mobile computing device indicates that the transaction is not authenticated. The mobile computing device may use any known method to indicate to the user that the transaction is not authenticated. In some embodiments, the mobile computing device may display a dialog box or other graphical interface to indicate that the transaction is not authenticated. In other embodiments, the mobile computing device may emit a sound and/or vibrate to indicate that the transaction is not authenticated.

Further, in some embodiments of block 335, if the mobile computing device indicates that the transaction is not authenticated, the process flow may return the block 320, where the user's mobile computing device prompts the user to authenticate the transaction. The process flow may then repeat the processes of block 320 to 335 any number of times until the user authenticates the transaction. Additionally, although not depicted in process flow 300, in some embodiments, if the user fails to property authenticate the transaction after a certain number of attempts (which can be predetermined by any party, including the user, the other party to the transaction, the user's financial institution, etc.), the user's mobile computing device may provide an indication that the transaction is cancelled because the user has failed to authenticate the transaction. Additionally, in some further embodiments, if the transaction is cancelled because the user failed to authenticate the transaction, the system configured to perform the steps of process flow 300 may be further configured to send a notice of the failed transaction to an email address, cell phone number, mailing address, or other contact information associated with a credit card or debit card that was used in the transaction.

Returning back to block 335, if the authentication data that was received by the mobile computing device at block 325 is valid, then the transaction is authenticated and the process flow 300 moves to block 345. At block 345, the user's mobile computing device indicates that the transaction is authenticated. The mobile computing device may use any known method to indicate to the user that the transaction is authenticated. In some embodiments, the mobile computing device may display a dialog box or other graphical interface to indicate that the transaction is authenticated. In other embodiments, the mobile computing device may emit a sound and/or vibrate to indicate that the transaction is authenticated.

### Transaction Authentication System and Environment

FIG. 4 provides a block diagram illustrating a system and environment 400 for authenticating a transaction at a point of transaction, in accordance with an embodiment of the invention. As illustrated in FIG. 4, the transaction authentication environment 400 includes a user 402. The environment 400 also includes a mobile computing device 500 belonging to user 402. As used herein, a “mobile computing device” is any mobile communication device, such as a cellular telecommunications device (i.e., a cell phone or mobile phone), personal digital assistant (PDA), a mobile Internet accessing device, or other mobile computing device.

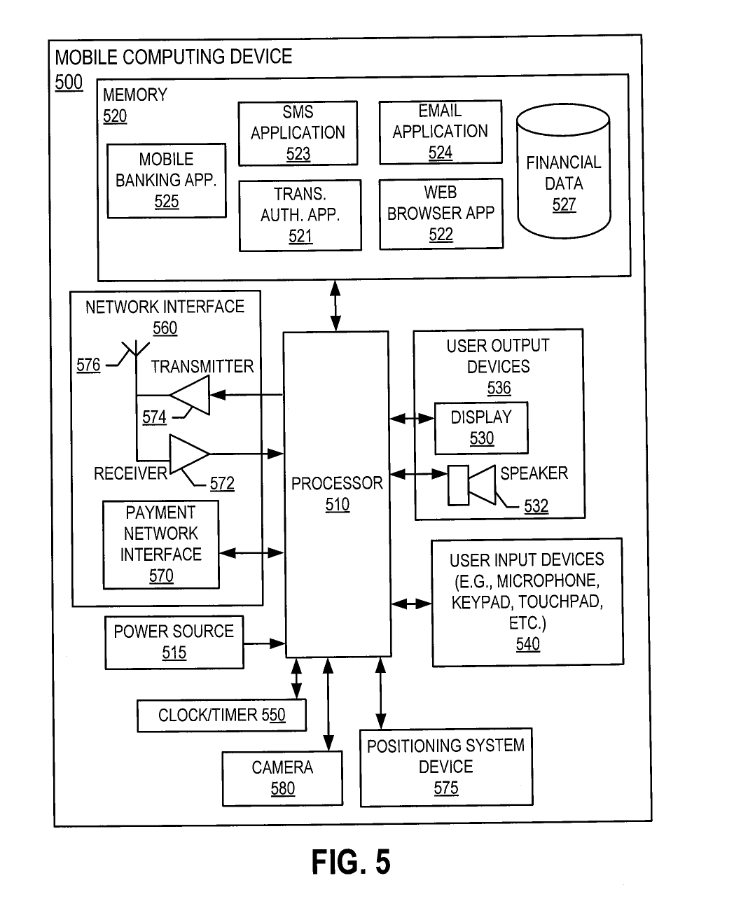

The mobile computing device 500, financial institution computer system 600, and point of transaction computer system 700 are each configured to communicate with each other over a network 450. The mobile computing device 500, financial institution computer system 600, and point of transaction computer system 700 and are each described in greater detail below with reference to FIGS. 5-7. The network 450 may include a local area network (LAN), a wide area network (WAN), a global area network (GAN), near field communication network, bluetooth network or any other type of communications network or protocol. In some embodiments, network 450 may comprise the Internet. In addition, network 450 may include first, second, third, and/or fourth-generation cellular communication networks and/or the like. For example, the network 450 may include second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, and/or the like. The network 450 may provide for wireline, wireless, or a combination of wireline and wireless communication between devices in the network.

In the embodiment of the invention depicted in FIG. 4, network 450 comprises near field communication (“NFC”) network 455, cellular network 460, and Internet 465. In some embodiments of the invention, mobile computing device 500 communicates with point of transaction computer system 600 over near field communication network 455. For example, mobile computing device 500 may communicate with point of transaction computer system 700 when mobile computing device 500 commences a transaction, as described in relation to block 210 of FIG. 2, and/or when mobile computing device 500 otherwise sends or receives information to/from point of transaction computer system 700. For instance, in some embodiments of the invention, mobile computing device 500 receives a request to authenticate a transaction from point of transaction computer system 700. Furthermore, in some embodiments, mobile computing device 500 sends authentication data (or an indication that authentication data is correct or not) to point of transaction computer system 700.

In some embodiments, point of transaction computer system 700 communicates with financial institution computer system 600 via Internet 465. For example, point of transaction computer system 700 may communicate with financial transaction computer system 600 when point of transaction computer system 700 uses authentication data to authenticate the transaction, as described in relation to block 235 of FIG. 2, and/or when point of transaction computer system 700 otherwise sends or receives information to/from financial institution computer system 600.

Lastly, in some embodiments mobile computing device 500 communicates with financial transaction computer system 600 via cellular network 460. For example, mobile computing device 500 communicates with financial transaction computer system 600 when mobile computing device 500 uses authentication data to authenticate the transaction, as described in relation to block 330 of FIG. 3, and/or when mobile computing device 500 otherwise sends or receives information to/from financial institution computer system 600. For instance, in some embodiments of the invention, mobile computing device 500 receives a request to authenticate a transaction from financial institution computer system 600. Furthermore, in some embodiments, mobile computing device 500 sends authentication data (or an indication that authentication data is correct or not) to financial institution computer system 600.

Although in the embodiment of the invention depicted in FIG. 4, point of transaction computer system 700 comprises a payment terminal, in some other embodiments of the invention (which are not depicted in FIG. 4), the payment terminal may be a separate device from point of transaction computer system 700. In those embodiments, mobile computing device 500 may similarly communicate with the payment terminal via network 450. Additionally, the payment terminal may communicate with point of transaction computer system 700 via network 450.

Referring now to FIG. 5, the mobile computing device 500 associated with the user 402 is described. FIG. 5 provides a block diagram illustrating mobile computing device 500 in accordance with embodiments of the invention. In one embodiment of the invention, the mobile computing device 500 is a mobile telephone. However, it should be understood, however, that a mobile telephone is merely illustrative of one type of mobile computing device 500 that may benefit from, employ, or otherwise be involved with embodiments of the present invention and, therefore, should not be taken to limit the scope of embodiments of the present invention. Other types of mobile computing devices 500 may include portable digital assistants (PDAs), pagers, mobile televisions, gaming devices, laptop computers, cameras, video recorders, audio/video player, radio, GPS devices, or any combination of the aforementioned.

The mobile computing device 500 generally includes a processor 510 communicably coupled to such devices as a memory 520, user output devices 536, user input devices 540, a network interface 560, a power source 515, a clock or other timer 550, a camera 580, and a positioning system device 575. The processor 510, and other processors described herein, generally include circuitry for implementing communication and/or logic functions of the mobile computing device 500. For example, the processor 510 may include a digital signal processor device, a microprocessor device, and various analog to digital converters, digital to analog converters, and/or other support circuits. Control and signal processing functions of the mobile computing device 500 are allocated between these devices according to their respective capabilities. The processor 510 thus may also include the functionality to encode and interleave messages and data prior to modulation and transmission. The processor 510 can additionally include an internal data modem. Further, the processor 510 may include functionality to operate one or more software programs, which may be stored in the memory 520. For example, the processor 510 may be capable of operating a connectivity program, such as a web browser application 522. The web browser application 522 may then allow the mobile computing device 500 to transmit and receive web content, such as, for example, location-based content and/or other web page content, according to a Wireless Application Protocol (WAP), Hypertext Transfer Protocol (HTTP), and/or the like.

The processor 510 is configured to use the network interface 560 to communicate with one or more other devices on the network 450. In this regard, the network interface 560 includes an antenna 576 operatively coupled to a transmitter 574 and a receiver 572 (together a “transceiver”). The processor 510 is configured to provide signals to and receive signals from the transmitter 574 and receiver 572, respectively. In some embodiments where network 350 is a wireless telephone network, the signals may include signaling information in accordance with the air interface standard of the applicable cellular system of the wireless telephone network. In this regard, the mobile computing device 500 may be configured to operate with one or more air interface standards, communication protocols, modulation types, and access types. By way of illustration, the mobile computing device 500 may be configured to operate in accordance with any of a number of first, second, third, and/or fourth-generation communication protocols and/or the like. For example, the mobile computing device 500 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, and/or the like. The mobile computing device 500 may also be configured to operate in accordance with non-cellular communication mechanisms, such as via a wireless local area network (WLAN), near field communication network, or other communication/data networks.

The network interface 560 may also include a payment network interface 570. The payment network interface 570 may include software, such as encryption software, and hardware, such as a modem, for communicating information to and/or from one or more devices on a network 350. For example, the mobile computing device 500 may be configured so that it can be used as a credit or debit card by, for example, wirelessly communicating account numbers or other authentication information to point of transaction computer system 600.

As described above, the mobile computing device 500 has a user interface that is, like other user interfaces described herein, made up of user output devices 536 and/or user input devices 540. The user output devices 536 include a display 530 (e.g., a liquid crystal display or the like) and a speaker 532 or other audio device, which are operatively coupled to the processor 510. The user input devices 540, which allow the mobile computing device 500 to receive data from user 402, may include any of a number of devices allowing the mobile computing device 500 to receive data from a user, such as a keypad, keyboard, touch-screen, touchpad, microphone, mouse, joystick, other pointer device, button, soft key, and/or other input device(s). The user interface may also include a camera 580, such as a digital camera.

The mobile computing device 500 may also include a positioning system device 575 that is configured to be used by a positioning system to determine a location of the mobile computing device 500. For example, the positioning system device 575 may include a GPS transceiver. In some embodiments, the positioning system device 575 is at least partially made up of the antenna 576, transmitter 574, and receiver 572 described above. For example, in one embodiment, triangulation of cellular signals may be used to identify the approximate location of the mobile computing device 500. In other embodiments, the positioning system device 575 includes a proximity sensor or transmitter, such as an RFID tag, that can sense or be sensed by devices known to be located proximate a merchant or other location to determine that the consumer mobile computing device 500 is located proximate these known devices.

The mobile computing device 500 further includes a power source 515, such as a battery, for powering various circuits and other devices that are used to operate the mobile computing device 500. Embodiments of the mobile computing device 500 may also include a clock or other timer 550 configured to determine and, in some cases, communicate actual or relative time to the processor 510 or one or more other devices.

The mobile computing device 500 also includes a memory 520 operatively coupled to the processor 510. As used herein, memory includes any computer readable medium (as defined herein below) configured to store data, code, or other information. The memory 420 may include volatile memory, such as volatile Random Access Memory (RAM) including a cache area for the temporary storage of data. The memory 520 may also include non-volatile memory, which can be embedded and/or may be removable. The non-volatile memory can additionally or alternatively include an electrically erasable programmable read-only memory (EEPROM), flash memory or the like.

The memory 520 can store any of a number of applications which comprise computer-executable instructions/code executed by the processor 510 to implement the functions of the mobile computing device 500 described herein. For example, the memory 520 may include such applications as a transaction authentication application 521, conventional web browser application 522, a SMS application 523, and email application 524 and/or mobile banking application 525. These applications also typically provide a graphical user interface (GUI) on the display 530 that allows user 402 to communicate with point of transaction computer system 700 and/or financial institution computer system 600. In some embodiments, memory 520 may store financial data 527. Financial data 527 may comprise and data or information relating to transactions of a user, such as credit card information, debit card information, bank account information, and/or information necessary to validate transactions involving the user. In some embodiments, financial data 527 may include the stored information that will be compared to user's inputted authentication data to determine if a transaction should be authenticated.

The memory 520 can also store any of a number of pieces of information, and data, used by the mobile computing device 500 and the applications and devices that make up the mobile computing device 500 or are in communication with the mobile computing device 500 to implement the functions of the mobile computing device 500 and/or the other systems described herein. For example, the memory 520 may include stored data that may be used to verify a user's authentication data, etc. to complete a transaction.

As used herein, a “processor” (such as the processor 510) or a “processing device,” generally refers to a device or combination of devices having circuitry used for implementing the communication and/or logic functions of a particular system. For example, a processor 510 may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processor 510 may further include functionality to operate one or more software programs based on computer-executable program code thereof, which may be stored in a memory. As the phrase is used herein, a processor 510 may be “configured to” perform a certain function in a variety of ways, including, for example, by having one or more general-purpose circuits perform the function by executing particular computer-executable program code embodied in computer-readable medium, and/or by having one or more application-specific circuits perform the function.

As used herein, a “memory” (such as memory 520) or “memory device,” generally refers to a device or combination of devices that store one or more forms of computer-readable media for storing data and/or computer-executable program code/instructions. Computer-readable media is defined in greater detail below. For example, in one embodiment, the memory 520 includes any computer memory that provides an actual or virtual space to temporarily or permanently store data and/or commands provided to the processor 510 when it carries out its functions described herein.

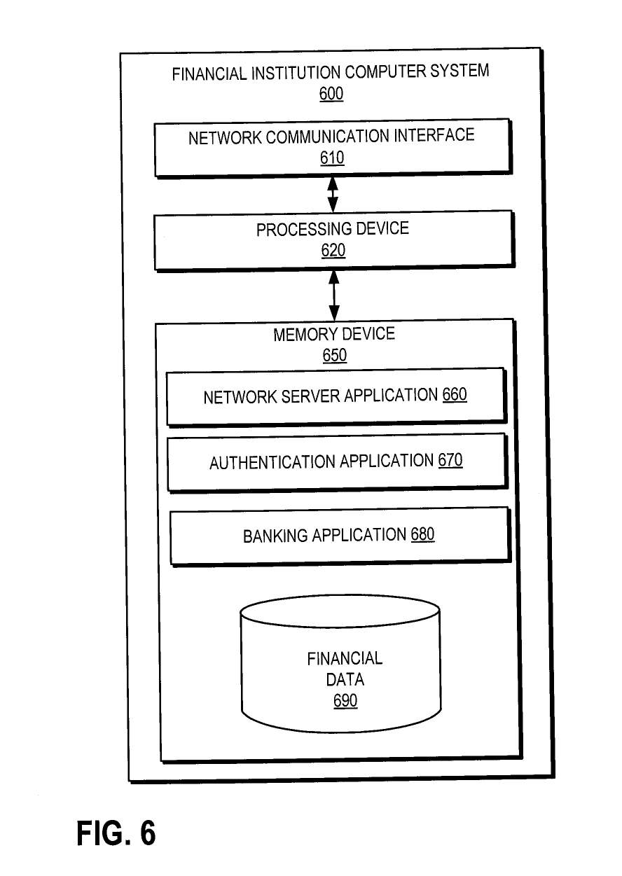

FIG. 6 provides a block diagram illustrating the financial institution computer system 600 in greater detail, in accordance with an embodiment of the invention. As illustrated in FIG. 6, in one embodiment of the invention, the financial institution computer system 600 includes a processing device 620 operatively coupled to a network communication interface 610 and a memory device 650. In certain embodiments, the financial institution computer system 600 is operated by a first entity, such as a financial institution, while in other embodiments, the financial institution computer system 600 is operated by an entity other than a financial institution.

It should be understood that the memory device 650 may include one or more databases or other data structures/repositories. The memory device 650 also includes computer-executable program code that instructs the processing device 620 to operate the network communication interface 610 to perform certain communication functions of the financial institution computer system 600 described herein. For example, in one embodiment of the financial institution computer system 600, the memory device 650 includes, but is not limited to, a network server application 660, an authentication application 670, banking application 680, and other computer-executable instructions or other data. In some embodiments of the invention, authentication application 670 performs the task of verifying authentication data by comparing the authentication data to stored information. The computer-executable program code of the network server application 660, the authentication application 670, or the banking application 680 may instruct the processing device 620 to perform certain logic, data-processing, and data-storing functions of the financial institution computer system 600 described herein, as well as communication functions of the financial institution computer system 600.

In one embodiment, memory device 650 includes financial data 690. Financial data 690 may comprise and data or information relating to transactions of a user, such as credit card information, debit card information, bank account information, and/or information necessary to validate transactions involving the user. In some embodiments, financial data 690 may include the stored information that will be compared to user inputted authentication data to determine if a transaction should be authenticated. The network server application 660, the authentication application 670, and/or the banking application 680 are configured to access financial data 690 when configured to perform the steps of the present invention.

While the embodiment of the invention depicted in FIG. 6 indicates that financial data 690 is stored in memory device 650 of financial institution computer system 600, in other embodiments of the invention, financial data 690 may be stored in memory devices in other computer systems, including computer systems operated by third parties. In such embodiments, financial institution computer system may still access the financial data 690 through the use of network communication interface 610.

As used herein, a “communication interface” generally includes a modem, server, transceiver, and/or other device for communicating with other devices on a network, and/or a user interface for communicating with one or more customers. Referring again to FIG. 6, the network communication interface 610 is a communication interface having one or more communication devices configured to communicate with one or more other devices on the network 450, such as the mobile computing device 500 and point of transaction computer system 700. The processing device 620 is configured to use the network communication interface 610 to transmit and/or receive data and/or commands to and/or from the other devices connected to the network 450.

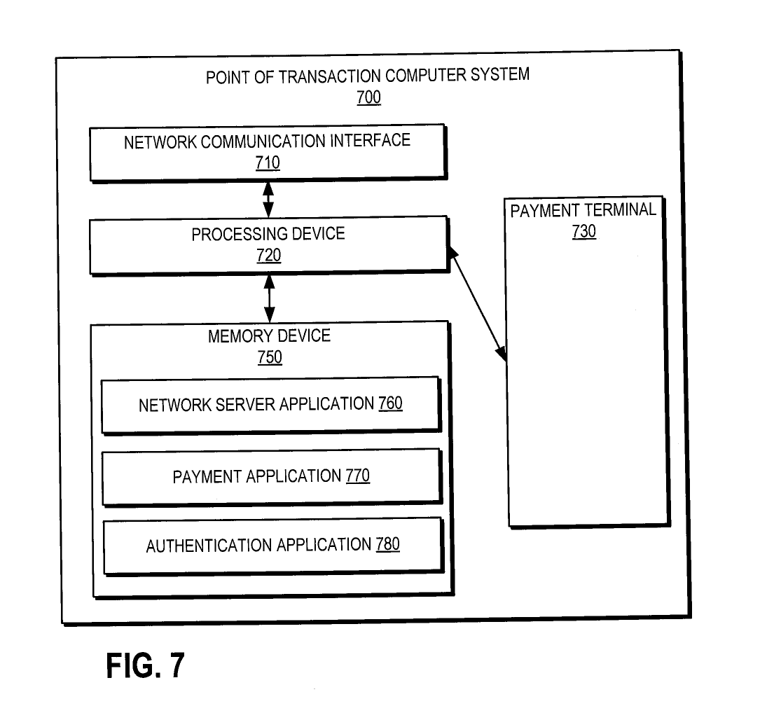

FIG. 7 provides a block diagram illustrating the point of transaction computer system 700 in greater detail, in accordance with an embodiment of the invention. As illustrated in FIG. 7, in one embodiment of the invention, the point of transaction computer system 700 includes a processing device 720 operatively coupled to a network communication interface 710 and a memory device 750. In certain embodiments, the financial institution computer system 700 is operated by a merchant or other commercial entity that may enter into transactions with the user.

It should be understood that the memory device 750 may include one or more databases or other data structures/repositories. The memory device 750 also includes computer-executable program code that instructs the processing device 720 to operate the network communication interface 710 to perform certain communication functions of the point of transaction computer system 700 described herein. For example, in one embodiment of the point of transaction computer system 700, the memory device 750 includes, but is not limited to, a network server application 760, payment application 770 and an authentication application 780. The computer-executable program code of the network server application 760, the payment application 770, or the authentication application 780 may instruct the processing device 720 to perform certain logic, data-processing, and data-storing functions of the point of transaction computer system 700 described herein, as well as communication functions of the point of transaction computer system 700. In some embodiments, point of transaction computer system 700 may execute payment application 770 to initiate functionality configured to conduct a transaction, such as initiating the functionality that allows a near field communication payment terminal to conduct transactions with a user's mobile phone. Additionally, in some embodiments, point of transaction computer system 700 may execute authentication application 780 to perform the functionality configured to authenticate a transaction, such as receiving authentication data from a mobile computing device.

Additionally, as illustrated in FIG. 7, point of transaction computer system 700 also includes payment terminal 730 operatively coupled to processing device 720. In this embodiment of the invention, payment terminal 730 is a NFC payment terminal that allows mobile device 500 to conduct financial transactions using e-wallet functionality. In this embodiment of the invention, payment terminal 730 may be located external to the rest of transaction computer system 700. Although not depicted in FIG. 7, in some embodiments of the invention, payment terminal 730 may include a processor, memory device, and communication interface. In some embodiments of the invention, payment terminal 730 may communicate with mobile device 500 over network 450 independent of network communication interface 710 and in some of these embodiments, information received by payment terminal 730 may be transmitted by network communication interface 710.

### Specific Embodiments of Transaction Authentication

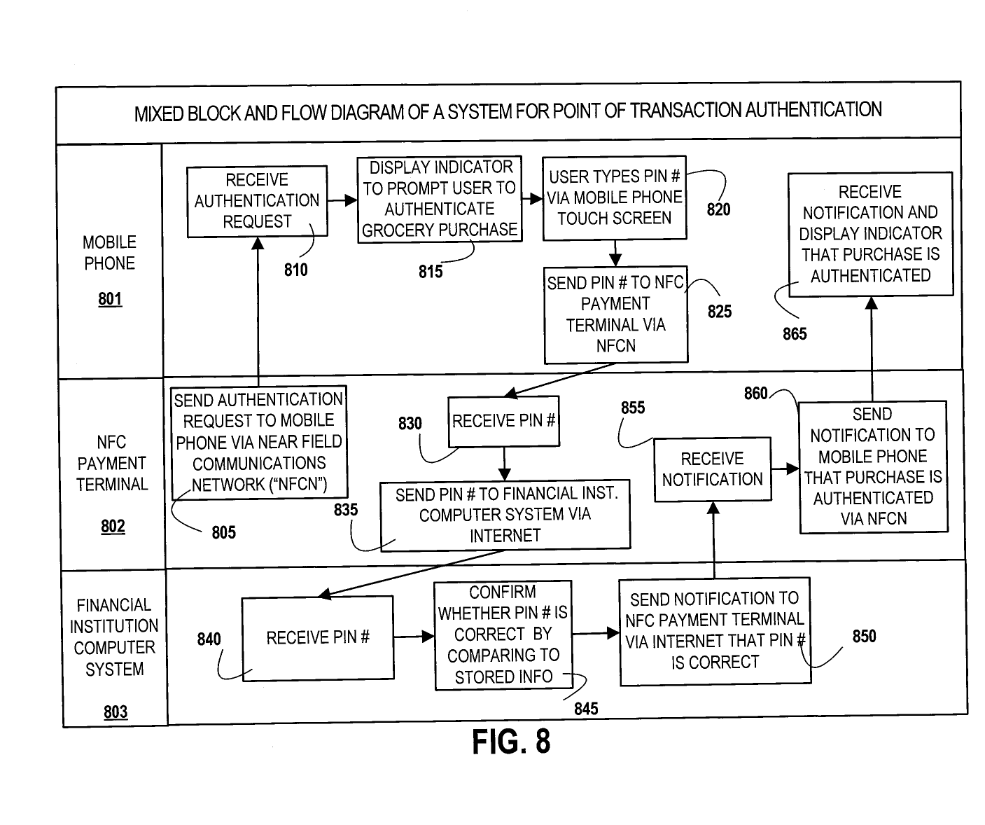

Referring now to FIG. 8, a mixed block and flow diagram of a system 800 for authenticating a transaction at a point of transaction. In general terms, FIG. 8 illustrates an embodiments of the invention in which the user uses a mobile phone 801 to authenticate a transaction at a near field communication payment terminal 802 (“NFC payment terminal 802”). Mobile phone 801 is one embodiment of mobile computing device 500 and NFC payment terminal 802 is one embodiment of payment terminal 730 that is operatively connected to point of transaction computer system 700. Additionally, it will be understood that the mixed block and flow diagram of a system 800 in FIG. 8 represents an embodiment of process flow 100 and process flow 200. As one of ordinary skill in the art will recognize, in this embodiment, where NFC payment terminal 802 is operatively connected to a point of transaction computer system, sending/receiving information or data to/from NFC payment terminal 802 may also comprise sending/receiving information or data to/from the point of transaction computer system.

It will be understood that FIG. 8 depicts a process flow in which a user is using mobile phone 801 to conduct a transaction at NFC payment terminal 802. In the embodiment of the invention depicted at FIG. 8, the user is at a grocery store and is seeking to purchase groceries using a debit card at NFC payment terminal 802. The user has already commenced the transaction by tapping the user's mobile phone 801 against the NFC payment terminal 802. Financial institution computer system 803 is maintained by the financial institution that issued the user's debit card.

As represented in block 805, after the user has used mobile phone 801 to commence the purchase of groceries, NFC payment terminal 802 sends an authentication request to mobile phone 801 via near field communications network. The NFC payment terminal 801 sends the authentication request in order to verify that the user is authorized to use the debit card that is being used for the purchase of groceries. At block 810, mobile phone 801 receives the authentication request from NFC payment terminal 802.

At block 815, mobile phone 801 displays an indicator prompting the user to authenticate the purchase. In this embodiment, the indicator appears as a graphic on the display of mobile phone 801 which prompts the user to authenticate the purchase. As one of skill in the art will appreciate, the indication can contain any type of text, images, and/or both in order to indicate to prompt the user to authenticate the purchase. In some other embodiments of the invention, mobile phone 801 may additionally or alternatively prompt the user by using sounds or making the phone vibrate. In this embodiment of the invention, mobile phone 801 prompts the user to authenticate the purchase by inputting a PIN number.

As represented in block 820, after viewing the indicator, the user types a PIN number via the touch screen of mobile phone 801. In other embodiments of the invention, the user could use a keypad to type the PIN number. In this embodiment of the invention, the user types the PIN number in order to authenticate the user's use of the debit card. As is know in the art, in some embodiments, when a user first activates a debit card, the user must choose a PIN number. Accordingly, subsequent transactions involving the debit card are authenticated by using the same PIN number. In this embodiment, the financial institution which issued the user's debit number, stores the PIN number in a memory device of financial institution computer system 803.

At block 825, after receiving the PIN number from the user at block 820, mobile phone 801 sends the PIN number to NFC payment terminal 802 via the near field communications network. As represented in block 830, NFC payment terminal 802 receives the PIN number from mobile phone 801. Subsequently, at block 835, NFC payment terminal 802 sends the PIN number to financial institution computer system 803 via the Internet. In some embodiments, NFC payment terminal 802 sends the PIN number to financial institution computer system 803 via the functionality of a point of transaction computer system (to which NFC payment terminal 803 is operatively connected). In some embodiments of the invention, the NFC payment terminal 802 accesses the Internet via a wireless network, wireline network and/or a combination of both. At block 840, financial institution computer system 803 receives the PIN number from NFC payment terminal 802.

As represented in FIG. 8, in block 845, the financial institution computer system 803 compares the PIN number that it received at block 840 to stored information. In this embodiment of the invention, the stored information is the correct PIN number that is associated with the user's debit card. In this embodiment of the invention, the correct PIN number that is associated with the user's debit card is stored in the memory of financial institution computer system 803, and financial institution computer system compares the PIN number it received at block 840 to the stored, correct PIN number. As indicated at block 845, the financial institution computer system 803 confirms that the PIN number received at block 840 is correct because it matches the stored PIN number.

At block 850, financial institution computer system 803 sends a notification to NFC payment terminal 802 (via the functionality of a point of transaction computer system to which NFC payment terminal 803 is operatively connected) that the PIN number that the user inputted at step 820 is correct. Financial institution computer system 803 sends this notification via the Internet. Financial institution computer system 803 accesses the Internet via a wireless network, wireline network and/or a combination of both. At block 855, NFC payment terminal 802 receives the notification that the PIN number that the user inputted at block 820 is valid (via the functionality of a point of transaction computer system to which NFC payment terminal 803 is operatively connected). Subsequently, at block 860, the NFC payment terminal 802 sends a notification to mobile phone 801 via the near field communication network that the purchase is authenticated. The purchase is authenticated because the PIN number that the user inputted at block 820 matches the stored information from block 845.

In other embodiments of block 850, financial institution computer system 803 may also send a notification directly to mobile phone 801 that the PIN number that the user inputted at step 820 is correct. Financial institution computer system 803 may send this notification via a cellular network. In such embodiments, where financial institution computer system 803 also sends a notification to mobile phone 801, the process flow would omit block 860.

At block 865, mobile phone 801 receives the notification from NFC payment terminal 802. Additionally, at block 865, mobile phone 801 displays an indicator that indicates that the purchase of groceries has been authenticated. In this embodiment, the indicator appears as a graphic on the display of mobile phone 801 which indicates to the user that the purchase has been authenticated. As one of skill in the art will appreciate, the indication can contain any type of text, images, and/or both in order to indicate to the user that the transaction has been authenticated. In some other embodiments of the invention, mobile phone 801 may additionally or alternatively indicate that the purchase has been authenticated by using sounds or making the phone vibrate. Once the user receives the indication that the purchase has been authenticated at block 865, the user is able to leave the grocery store with the groceries that the user just purchased through the use of mobile phone 801.

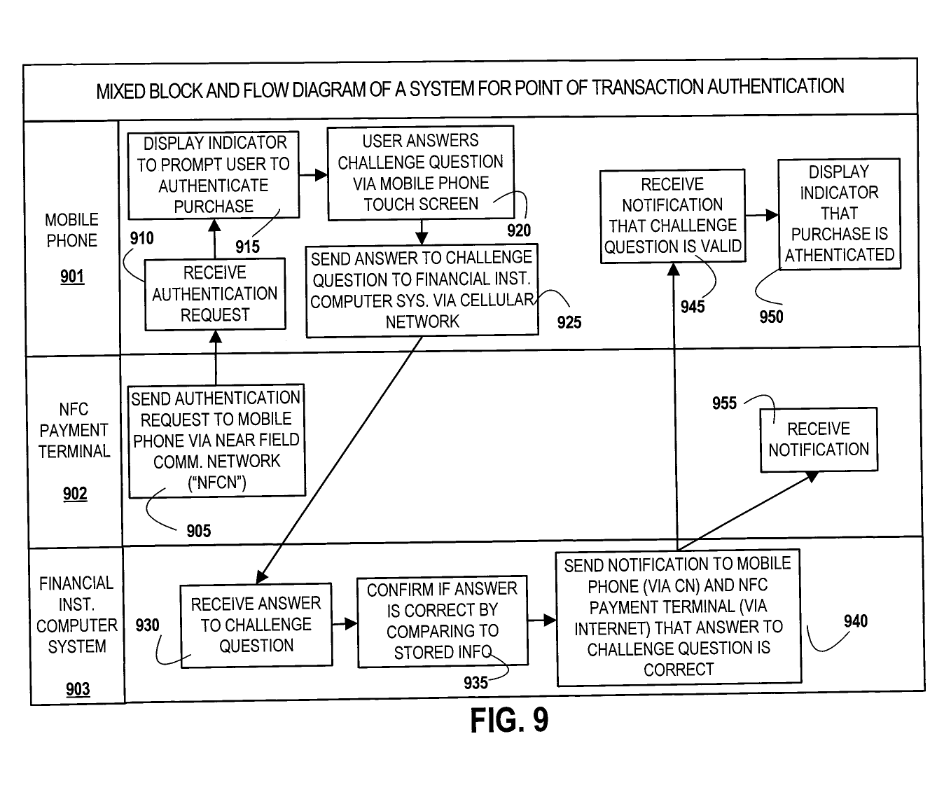

Referring now to FIG. 9, a mixed block and flow diagram of a system 900 for authenticating a transaction at a point of transaction. In general terms, FIG. 9 illustrates an embodiments of the invention in which the user uses a mobile phone 901 to authenticate a transaction at a near field communication payment terminal 902 (“NFC payment terminal 902”). Mobile phone 901 is one embodiment of mobile computing device 500 and NFC payment terminal 902 is one embodiment of payment terminal 730 that is operatively connected to point of transaction computer system 700. Additionally, it will be understood that the mixed block and flow diagram of a system 900 in FIG. 9 represents an embodiment of process flow 100 and process flow 300. As one of ordinary skill in the art will recognize, in this embodiment, where NFC payment terminal 902 is operatively connected to a point of transaction computer system, sending/receiving information or data to/from NFC payment terminal 902 may also comprise sending/receiving information or data to/from the point of transaction computer system.

It will be understood that FIG. 9 depicts a process flow in which a user is using mobile phone 901 to conduct a transaction at NFC payment terminal 902. In the embodiment of the invention depicted at FIG. 9, the user is at a grocery store and is seeking to purchase groceries using a debit card at NFC payment terminal 902. The user has already commenced the transaction by tapping the user's mobile phone 901 against the NFC payment terminal 902. Financial institution computer system 903 is maintained by the financial institution that issued the user's debit card.

As represented in block 905, after the user has used mobile phone 901 to commence the purchase of groceries, NFC payment terminal 902 sends an authentication request to mobile phone 901 via near field communications network. The NFC payment terminal 901 sends the authentication request in order to verify that the user is authorized to use the debit card that is being used for the purchase of groceries. At block 910, mobile phone 901 receives the authentication request from NFC payment terminal 902.

At block 915, mobile phone 901 displays an indicator prompting the user to authenticate the purchase. In this embodiment, the indicator appears as a graphic on the display of mobile phone 901 which prompts the user to authenticate the purchase. As one of skill in the art will appreciate, the indication can contain any type of text, images, and/or both in order to indicate to prompt the user to authenticate the purchase. In some other embodiments of the invention, mobile phone 901 may additionally or alternatively prompt the user by using sounds or making the phone vibrate. In this embodiment of the invention, mobile phone 901 prompts the user to authenticate the purchase by answering a challenge question.

As represented in block 920, after viewing the indicator, the user types the answer to the challenge question via the touch screen of mobile phone 901. In other embodiments of the invention, the user could use a keypad to type the answer to the challenge question. In this embodiment of the invention, the user types the answer to the challenge question in order to authenticate the user's use of the debit card. As is know in the art, in some embodiments, when a user first activates a debit card, the user may choose a challenge question to authenticate use of the debit card. Accordingly, subsequent transactions involving the debit card are authenticated by providing a correct answer to the challenge question. In this embodiment, the financial institution which issued the user's debit card, stores the correct answer to the challenge question in a memory device financial institution computer system 803.

At block 925, after receiving the answer to the challenge question from the user at block 920, mobile phone 901 sends the answer to the challenge question to financial institution computer system 903 via a cellular network connected to the Internet. At block 930, financial institution computer system 903 receives the answer to the challenge question from mobile phone 901.

As represented in FIG. 9, in block 935, the financial institution computer system 903 compares the answer to the challenge question that it received at block 930 to stored information. In this embodiment of the invention, the stored information is the correct answer to the challenge question that is associated with the user's debit card. In this embodiment of the invention, the correct answer to the challenge question that is associated with the user's debit card is stored in the memory of financial institution computer system 903, and financial institution computer system compares the answer that it received at block 930 to the stored, correct answer. As indicated at block 935, the financial institution computer system 903 confirms that the answer that it received at block 930 is correct because it matches the stored answer

At block 940, financial institution computer system 903 sends a notification to mobile phone 801 and NFC payment terminal 802 that the answer that the user inputted at step 920 is correct. Financial institution computer system 903 sends this notification to mobile phone 801 via the Internet connected to a cellular network. Financial institution computer system 803 accesses the Internet via a wireless network, wireline network and/or a combination of both. At block 945, mobile phone 901 receives the notification that the answer that the user inputted at block 920 is valid. Additionally, at block 940, the financial institution computer system 903 sends a notification via the Internet to NFC payment terminal 902 that the challenge question is correct and the purchase is authenticated. The purchase is authenticated because the answer that the user inputted at block 920 matches the stored data from block 935. The NFC payment terminal receives this notification via the Internet network at block 955.

Additionally, at block 950, mobile phone 901 displays an indicator that indicates that the purchase of groceries has been authenticated. In this embodiment, the indicator appears as a graphic on the display of mobile phone 901 which indicates to the user that the purchase has been authenticated. As one of skill in the art will appreciate, the indication can contain any type of text, images, and/or both in order to indicate to the user that the transaction has been authenticated. In some other embodiments of the invention, mobile phone 901 may additionally or alternatively indicate that the purchase has been authenticated by using sounds or making the phone vibrate. Once the user receives the indication that the purchase has been authenticated at block 950, the user is able to leave the grocery store with the groceries that the user just purchased through the use of mobile phone 901.

Although not indicated in FIG. 9, in some embodiments of block 940, the financial institution computer system 903 does not send a notification to NFC payment terminal 902 that the answer to the challenge question is correct and the purchase is authenticated. In such embodiments, mobile phone 901 may send such a notification to NFC payment terminal 902 as part of the process of block 950.

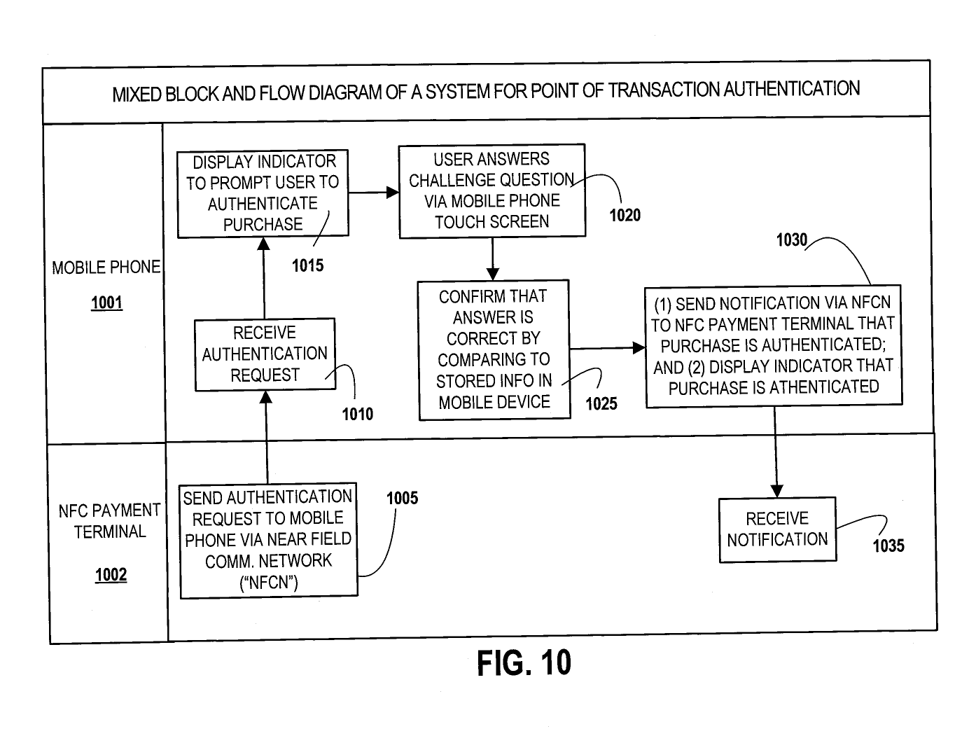

Referring now to FIG. 10, a mixed block and flow diagram of a system 1000 for authenticating a transaction at a point of transaction. In general terms, FIG. 10 illustrates an embodiments of the invention in which the user uses a mobile phone 1001 to authenticate a transaction at a near field communication payment terminal 1002 (“NFC payment terminal 902”). Mobile phone 1001 is one embodiment of mobile computing device 500 and NFC payment terminal 1002 is one embodiment of payment terminal 730 that is operatively connected to point of transaction computer system 700. Additionally, it will be understood that the mixed block and flow diagram of a system 1000 in FIG. 10 represents an embodiment of process flow 100 and process flow 300. In particular, FIG. 10 represents an embodiment of the invention where mobile computing device 500 authenticates the transaction without communicating with a financial institution computer system. As one of ordinary skill in the art will recognize, in this embodiment, where NFC payment terminal 1002 is operatively connected to a point of transaction computer system, sending/receiving information or data to/from NFC payment terminal 1002 may also comprise sending/receiving information or data to/from the point of transaction computer system.

It will be understood that FIG. 10 depicts a process flow in which a user is using mobile phone 1001 to conduct a transaction at NFC payment terminal 1002. In the embodiment of the invention depicted at FIG. 10, the user is at a grocery store and is seeking to purchase groceries using a debit card at NFC payment terminal 1002. The user has already commenced the transaction by tapping the user's mobile phone 1001 against the NFC payment terminal 1002.

As represented in block 1005, after the user has used mobile phone 1001 to commence the purchase of groceries, NFC payment terminal 1002 sends an authentication request to mobile phone 1001 via near field communications network. The NFC payment terminal 1001 sends the authentication request in order to verify that the user is authorized to use the debit card that is being used for the purchase of groceries. At block 1010, mobile phone 1001 receives the authentication request from NFC payment terminal 1002.

At block 1015, mobile phone 1001 displays an indicator prompting the user to authenticate the purchase. In this embodiment, the indicator appears as a graphic on the display of mobile phone 1001 which prompts the user to authenticate the purchase. As one of skill in the art will appreciate, the indication can contain any type of text, images, and/or both in order to indicate to prompt the user to authenticate the purchase. In some other embodiments of the invention, mobile phone 1001 may additionally or alternatively prompt the user by using sounds or making the phone vibrate. In this embodiment of the invention, mobile phone 901 prompts the user to authenticate the purchase by answering a challenge question.

As represented in block 1020, after viewing the indicator, the user types the answer to the challenge question via the touch screen of mobile phone 1001. In other embodiments of the invention, the user could use a keypad to type the answer to the challenge question. In this embodiment of the invention, the user types the answer to the challenge question in order to authenticate the user's use of the debit card. As is know in the art, in some embodiments, when a user first activates a debit card, the user may choose a challenge question to authenticate use of the debit card. Accordingly, subsequent transactions involving the debit card are authenticated by providing a correct answer to the challenge question. In this embodiment, mobile phone 1001, stores the correct answer to the challenge question in a memory device.

At block 1025, after receiving the answer to the challenge question from the user at block 1020, mobile phone 1001 determines if the answer to the challenge question that it received at block 1025 is correct by comparing it to stored information. In this embodiment of the invention, the stored information is the correct answer to the challenge question that is associated with the user's debit card. In this embodiment of the invention, the correct answer to the challenge question that is associated with the user's debit card is stored in the memory of mobile phone 1001 As indicated at block 1025, mobile phone 1001 confirms that the answer received at block 1020 is correct because it matches the stored answer

At block 1030, the mobile phone 1001 sends a notification via the near field communication network to NFC payment terminal 1002 that the purchase is authenticated. The purchase is authenticated because the answer that the user inputted at block 1020 matches the stored data from block 1025. The NFC payment terminal receives this notification via the near field communication network at block 1035.

Additionally, at block 1030, mobile phone 1001 displays an indicator that indicates that the purchase of groceries has been authenticated. In this embodiment, the indicator appears as a graphic on the display of mobile phone 1001 which indicates to the user that the purchase has been authenticated. As one of skill in the art will appreciate, the indication can contain any type of text, images, and/or both in order to indicate to the user that the transaction has been authenticated. In some other embodiments of the invention, mobile phone 901 may additionally or alternatively indicate that the purchase has been authenticated by using sounds or making the phone vibrate. Once the user receives the indication that the purchase has been authenticated at block 1030, the user is able to leave the grocery store with the groceries that the user just purchased through the use of mobile phone 1001.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, etc.), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatuses and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g., a memory, etc.) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s)

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

1. A method for allowing a user to authenticate a financial transaction, the method comprising:
receiving wirelessly, at a mobile computing device associated with the user, a request from a point of transaction device to authenticate the financial transaction;
prompting the user, via the mobile computing device, to authenticate the financial transaction by displaying a user interface on the display of the mobile computing device;
receiving at the mobile computing device, based upon the user's interaction with the user interface displayed on the display of the mobile computing device, authentication data from the user;
determining, at the mobile computing device, that the authentication data from the user is correct; and
sending wirelessly from the mobile computing device an indication that the authentication data is correct to the point of transaction device.

2. (canceled)

3. (canceled)

4. The method of claim 1, wherein receiving a request from a point of transaction device to authenticate a financial transaction comprises receiving a request wirelessly via a near field communication network.

5. The method of claim 1, wherein receiving, based upon the user's interaction with the user interface displayed on the display of the mobile computing device, authentication data from the user comprises receiving a PIN number.

6. The method of claim 1, wherein receiving, based upon the user's interaction with the user interface displayed on the display of the mobile computing device, authentication data from the user comprises receiving an answer to a challenge question.

7. The method of claim 1, wherein receiving, based upon the user's interaction with user interface displayed on the display of the mobile computing device, authentication data from the user comprises receiving biometric information;

8. The method of claim 7 wherein receiving biometric information comprises receiving information relating to the user's voice.

9. (canceled)

10. The method of claim 1, further comprising the step of sending wirelessly from the mobile computing device information associated with the authentication data to a network device in communication with the mobile computing device.

11. (canceled)

12. (canceled)

13. (canceled)

14. (canceled)

15. The method of claim 1, wherein the mobile computing device is a mobile phone.

16. The method of claim 1, wherein receiving, at a mobile computing device associated with the user, a request from a point of transaction device to authenticate the financial transaction comprises receiving a request to authenticate a purchase before the user reaches the point of transaction device.

17. An apparatus comprising:
a communication device;
a display;
and a processing device communicably coupled to the communication device, wherein the processing device:
receives wirelessly a request from a point of transaction device to authenticate a financial transaction;
prompts a user to authenticate the financial transaction by displaying a user interface on the display;
receives authentication data from the user based upon the user's interaction with the user interface;
determines that the authentication data from the user is correct; and
sends wirelessly an indication that the authentication data is correct to the point of transaction device.

18. (canceled)

19. (canceled)

20. The apparatus of claim 17, wherein the apparatus receives the request to authenticate a financial transaction via a near field communication network.

21. The apparatus of claim 17, wherein the authentication data comprises a PIN number.

22. The apparatus of claim 17, wherein the authentication data comprises an answer to a challenge question.

23. The apparatus of claim 17, wherein the authentication data comprises biometric information;

24. The apparatus of claim 23 wherein the biometric information comprises information relating to the user's voice.

25. (canceled)

26. (canceled)

27. The apparatus of claim 17, wherein the processing device further sends wirelessly information associated with the authentication data to a network device in communication with the apparatus.

28. (canceled)

29. (canceled)

30. (canceled)

31. (canceled)

32. The apparatus of claim 17, wherein the apparatus is a mobile phone.

33. The apparatus of claim 17, wherein the apparatus receives the request to authenticate the financial transaction before the user reaches the point of transaction device.

34. A computer program product for authenticating a transaction, the computer program product comprising a non-transitory, computer-readable medium having computer readable program instructions stored therein, wherein said computer-readable program instructions comprise:
first instructions for wirelessly receiving at a mobile computing device a from a point of transaction device request to authenticate a financial transaction;
second instructions for prompting a user to authenticate the financial transaction by displaying a user interface on the display of the mobile computing device;
third instructions for receiving authentication data from the user based on the user's interaction with the user interface displayed on the display of the mobile computing device;
fourth instructions for determining that the authentication data from the user is correct;
fifth instructions for sending wirelessly from the mobile computing device an indication that the authentication data is correct to the point of transaction device.

35. (canceled)

36. (canceled)

37. The computer program product of claim 34, wherein the first instructions for receiving wirelessly from a point of transaction device a request to authenticate a financial transaction comprise instructions for receiving wirelessly a request to authenticate a financial transaction from a point of transaction device via a near field communication network.

38. The computer program product of claim 34, wherein the third instructions configured to receive authentication data from the user based on the user's interaction with the user interface displayed on the display on the mobile device comprise instructions for receiving a PIN number from the user.

39. The computer program product of claim 34, wherein the third instructions configured to receive authentication data from the user based on the user's interaction with the user interface displayed on the display on the mobile device comprise instructions for receiving an answer to a challenge question from the user.

40. The computer program product of claim 34, wherein the third instructions configured to receive authentication data from the user based on the user's interaction with the user interface displayed on the display on the mobile device comprise instructions for receiving biometric information from the user;

41. The computer program product of claim 40, wherein the third instructions configured to receive biometric information from the user further comprise instructions for receiving information relating to the user's voice.

42. (canceled)

43. The computer program product of claim 34, further comprising sixth instructions for sending wirelessly the authentication data from the mobile computing device to a network device in communication with the mobile computing device.

44. (canceled)

45. (canceled)

46. (canceled)

47. (canceled)

48. The computer program product of claim 34, wherein the first instructions for receiving from a point of transaction device a request to authenticate a financial transaction comprise instructions for receiving a request to authenticate a purchase before the user reaches the point of transaction device.

49. The method of claim 10, wherein determining that the authentication data is correct comprises receiving wirelessly, at the mobile computing device, an indication from the network device in communication with the mobile computing device that the authentication data is correct.

50. The method of claim 1, wherein determining that the authentication data is correct comprises comparing the authentication data to information stored in the memory of the mobile computing device.

51. The method of claim 1, further comprising the step of receiving wirelessly, at the mobile computing device, an indication from the point of transaction device that the mobile computing device is within the proximity of the point of transaction device.

52. The method of claim 1, wherein receiving wirelessly a request from a point of transaction device comprises receiving wirelessly a request from a point of transaction device that lacks any functionality for swiping a card or inputting PIN numbers to authenticate a transaction.

53. The method of claim 1, wherein receiving, at a mobile computing device associated with the user, a request from a point of transaction device to authenticate the financial transaction comprises receiving a request to authenticate a purchase after the user has commenced paying for the purchase at the point of transaction device.

54. The apparatus of claim 27, wherein the processing device further receives wirelessly an indication from the network device that the authentication data is correct.

55. The apparatus of claim 17, wherein the apparatus further comprises a memory device and wherein the processing device is further configured to compare the authentication data to information stored in the memory device.

56. The apparatus of claim 17, wherein the processing device further receives wirelessly an indication from the point of transaction device that the apparatus is within the proximity of the point of transaction device.

57. The apparatus of claim 17, wherein the apparatus receives wirelessly a request from a point of transaction device that lacks any functionality for swiping a card or inputting PIN numbers to authenticate a transaction.

58. The apparatus of claim 17, wherein the apparatus receives the request to authenticate the financial transaction after the user has commenced paying for the purchase at the point of transaction device.

59. The computer program product of claim 43, further comprising seventh instructions for receiving wirelessly an indication from the network device that the authentication data is correct.

60. The computer program product of claim 34, wherein the fourth instructions for determining that the authentication data from the user is correct comprise instructions for comparing the authentication data to information stored in the memory device of a mobile computing device.

61. The computer program product of claim 34, further comprising sixth instructions for receiving wirelessly an indication from the point of transaction device that the mobile computing device is within the proximity of the point of transaction device.

62. The computer program product of claim 34, wherein the first instructions for receiving from a point of transaction device a request to authenticate a financial transaction comprise instructions for receiving a request from a point of transaction device that lacks any functionality for swiping a card or inputting PIN numbers to authenticate a transaction.

63. The computer program product of claim 34, wherein the first instructions for receiving from a point of transaction device a request to authenticate a financial transaction comprise instructions for receiving a request to authenticate a purchase after the user has commenced paying for the purchase at the point of transaction device.
